(19) United States
(12) Patent Application Publication
(10) Pub. No.: US 2005/0098658 A1
(43) Pub. Date: May 12, 2005

(54) Pre-rinse assembly

(76) Inventor: David J. Burke, Brick, NJ (US)

Correspondence Address: Francis C. Hand, Esq.;c/o Carella, Byme, Bain, Gilfillan, Cecchi,, Stewart & Olstein, 5 Becker Farm Road, Roseland, NJ, 07068, US

(21) Appl. No.: 10/706,709

(22) Filed: Nov. 12, 2003

(51) Int. Cl. A62C 31/02; B05B 7/02

(52) U.S. Cl. 239/525; 239/391; 239/394; 239/437; 239/530

(57) ABSTRACT

The spray head of the spray head assembly of the pre-rinse assembly has five different positions to deliver five different types of water patterns.The spray head has internal ports that communicate with openings that have spouts or an aperturedplate to delivera full full stream, a jet stream or a mist. In addition, the spray head has ports that communicate with two separate internal chambers that, in turn, communicate with a pair of concentric rings of openings to deliver a center spray pattern or a shower spray pattern of water. The spray head can be used to wash or rinse utensils that need cleaning, to scour adhered food particles from utensils using a jet spray, and to apply a mist or shower pattern to foods that need refreshing or cleaning.

This invention relates to a pre-rinse assembly. More particularly, this invention relates to a pre-rinse assembly dicharging water in different spray patterns.

As is known, various types of water-spray assemblies have been employed for the rinsing and washing of dishes, pots, pans, utensils and the like in commercial and institutional establishments. Typically, these water-spray assemblies are mounted on or adjacent sinks and are manipulated manually by a dishwasher in order to deliver streams or sprays of water onto the items to be rinsed in the sink. In many cases, the spray assemblies employ a flexible hose, which is connected to a water-riser pipe to receive a flow of water and a spray-head at the end of the hose to deliver multiple sprays of water onto the items to be rinsed.

Generally, the spray assemblies have been provided with a spray head that is able to deliver a single flow of water for washing purposes or multiple streams in a spray for rinsing purposes.

It is an object of this invention to provide a pre-rinse assembly that has a spray-head assembly capable of delivering three or more different types of water patterns to accommodate the cleaning desired.

It is another object of the invention to provide a spray-head assembly that can be used to deliver different flow patterns selected from a jet-stream, mist pattern, shower pattern, center pattern or conventional fall spray pattern.

It is another object of the invention to provide a spray-head assembly that can be easily manipulated by hand to deliver different patterns of water spray for various purposes.

Briefly, the invention provides a pre-rinse assembly comprised of a hose sub-assembly, a grip and a spray-head assembly.

The hose sub-assembly is of any suitable construction having an inlet end for connecting to a riser and a discharge end at an opposite end.

The grip is of any suitable construction and is secured to the discharge end of the hose sub-assembly and has a duct for a flow of water.

The spray-head assembly includes a housing that is secured to the grip and that has a passage in communication with the grip in order to conduct a flow of water therefrom as well as a spray-head rotatably mounted on the housing. The spray head has a plurality of ports for selective communication with the passage in the housing in order to discharge water therefrom in a predetermined spray pattern.

In accordance with the invention, the spray head has at least three circumferentially spaced-apart outlets for selective communication with the passage in the housing. One of these outlets has a spout of cylindrical shape to discharge a single full stream of water therethrough. A second of the outlets has a spout of smaller diameter than the first spout to discharge a jet stream of water therethrough. The third of the outlets is provided with a plate with a plurality of openings to discharge a water mist therethrough.

The spray head is constructed so that it may be readily rotated relative to the housing in order to bring a selected outlet in the spray head into communication with the passage in the housing of the spray-head assembly. Thus, a user may adjust the spray-head assembly into a position to direct a full stream of water into a sink for washing food particles and the like from dishes, pots or pans, and the like. Where the food particles are more adherent to the utensil, the user may rotate the spray head into position to discharge a jet-stream of water onto the utensils in order to drive off adhered food particles. In a similar manner, the spray-head may be rotated into position to allow a mist to be discharged, for example, for refreshing food items, such as lettuce.

The spray-head is also provided with a first set of concentric rings of openings for selective communication with the passage in the second housing for discharging a plurality of water streams therethrough in a central pattern. These rings of openings are disposed centrally within the first three outlets.

Still further, the spray-head is provided with a second set of concentric rings of openings for selective communication with the passage in the second housing for discharging a plurality of water streams therethrough in a shower pattern. These concentric rings of outlets are disposed peripherally of the spray-head, that is, outside the first three outlets.

The spray-head is also provided internally with a plurality of circumferentially spaced recesses while a spring-biased detent is disposed in the housing for selective placement coaxially in one of the recesses in order to retain the spray-head in a selected position relative to the housing.

These and other objects and advantages of the invention will become more apparent from the following detailed description taken in conjunction with the accompanying drawings, wherein

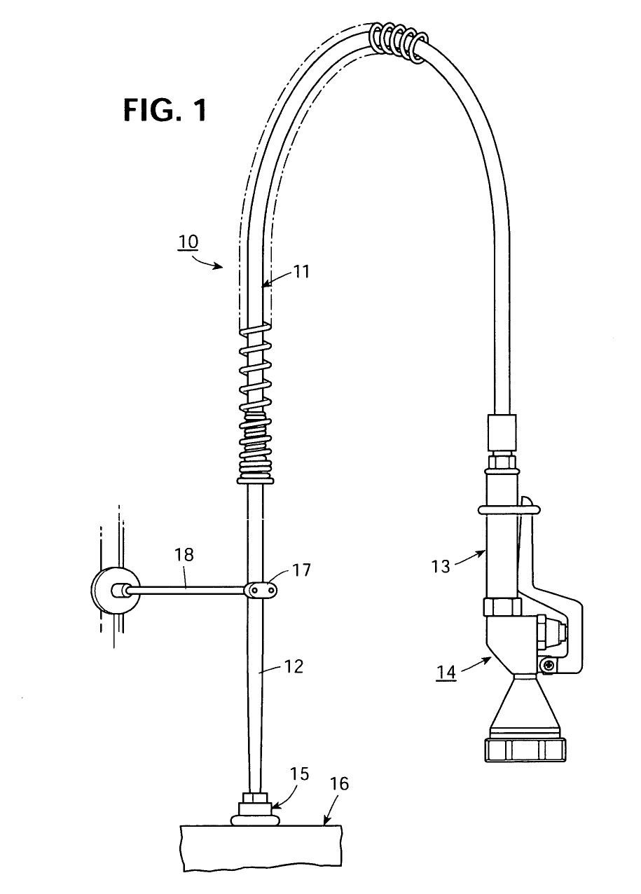

FIG. 1 illustrates a spray head assembly constructed in accordance with the invention;

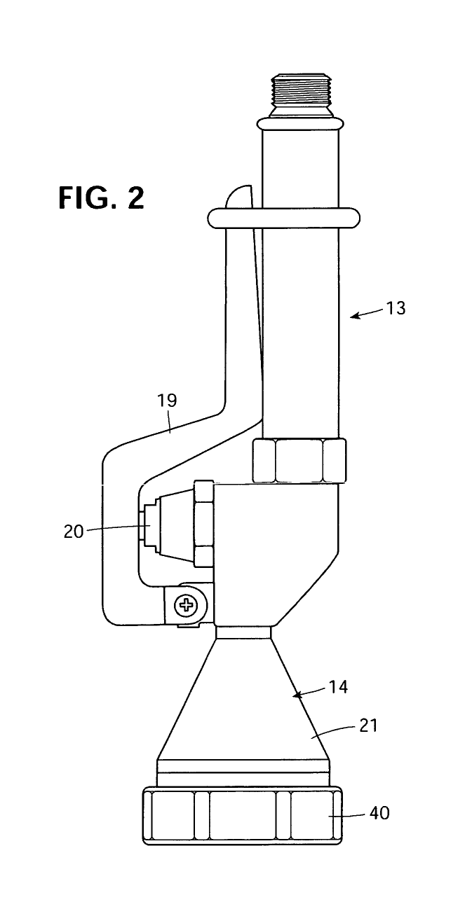

FIG. 2 illustrates a view of a spray head assembly mounted on a grip in accordance with the invention;

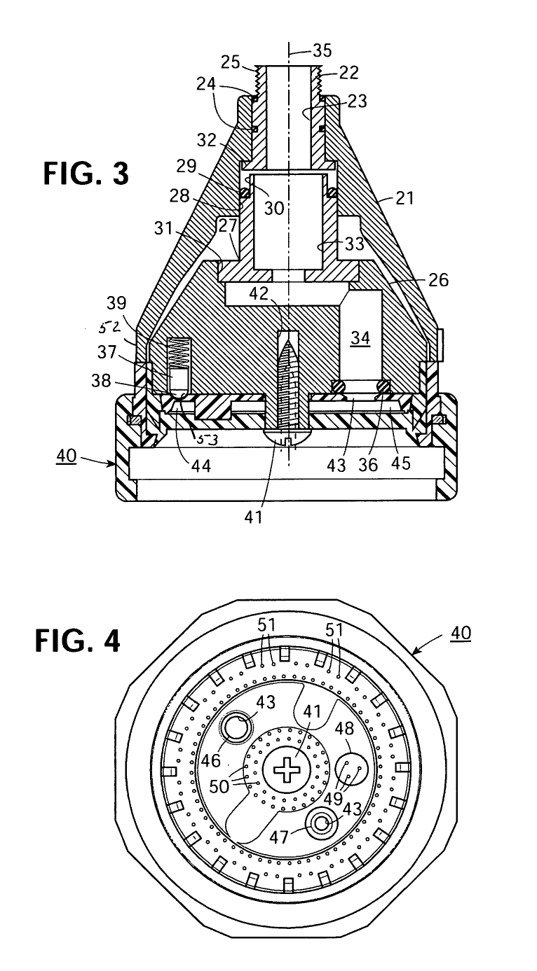

FIG. 3 illustrates a cross-sectional view of the spray head assembly of FIG. 2;

FIG. 4 illustrates a front view of the spray head of FIG. 3; and

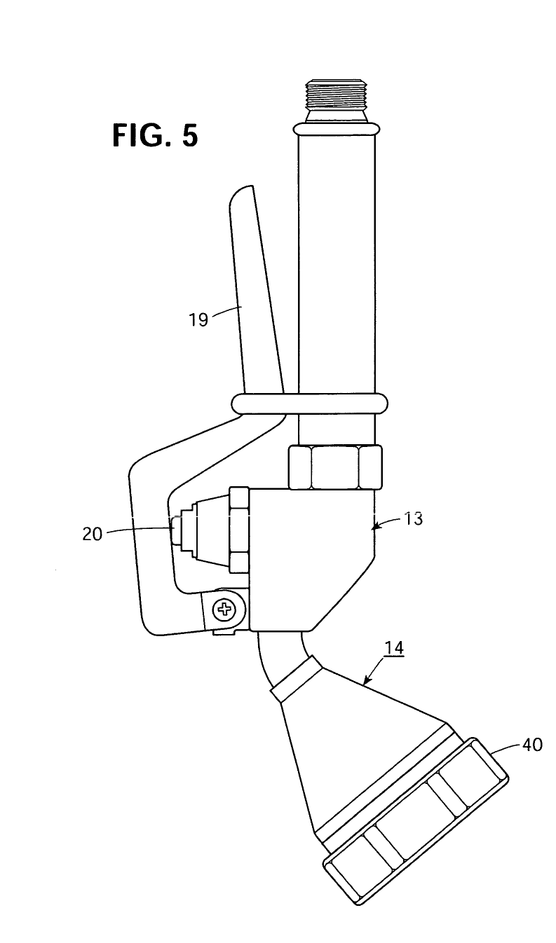

FIG. 5 illustrates a view of a modified spray-head assembly constructed in accordance with the invention.

Referring to FIG. 1, the pre-rinse assembly 10 includes a hose sub-assembly 11 that extends from a riser 12, a grip 13 and a spray head assembly 14. By way of example, the riser 12 is in the form of a vertical pipe through which water may flow from a tap 15 on a sink 16. As shown, the riser 12 is secured at an intermediate point via a clamp 17 to a wall bracket 18.

The hose sub-assembly 11 has an inlet end secured to the riser 12 as well as a discharge end that is secured to the grip 13.

Referring to FIG. 2, the grip 13 is provided with a handle 19 and valve assembly 20 of conventional structure that can be actuated in order to pass water through the grip 13 into the spray head assembly 14.

Referring to FIG. 3, the spray-head assembly 14 includes a housing 21 of conical shape and a hollow connector 22 that is mounted in and that projects from the housing 21. The connector 22 defines a passage 23 for the flow of water from the grip 13 (not shown) and that is of hexagonal inner shape for assembly purposes as explained below.

A pair of O-rings 24 are disposed between the outer periphery of the connector 22 and an inner periphery of the housing 21 in a compressed manner to preclude relative rotation between the housing 21 and the connector 22 and also to provide circumferential seals between the housing 21 and the connector 22. The exposed end of the connector 22 has an external male thread 25 in order to be threaded into the grip 13.

The spray-head assembly 14 also includes an inner housing 26 that is secured to and within the first housing 21. As shown, a hollow plug 27 of cylindrical shape is fixedly mounted in a circular recess 31 in the inner housing 26 and is of a length to extend up to the connector 22 to form a flow path for a flow of water from the connector 22. The hollow plug 27 is slidably mounted within a cylindrical counter-bore 28 in the outer housing 21. An O-ring 29 is mounted on a shoulder 30 of the plug 27 in order to seal against the housing 21.

As shown, the connector 22 has a collar 32 that is seated against a shoulder of the housing 21.

The plug 27 has a bore 33 in an end wall to allow the passage of water from the connector 22 through the plug 27 into the inner housing 26.

The inner housing 26 includes a passage 34 in communication with the passage in the connector 22 to convey water therethrough. This passage 34 is offset from a central axis 35 of the spray-head assembly. An O-ring 36 is seated at the terminal end of the passage 34.

As illustrated, the inner housing 26 is provided with a counter-bore 37 at the discharge end and receives a plunger 38 and a spring 39 that biases the plunger 38 in a direction out of the bore 37 for purposes as described below.

In assembling the spray-head assembly 14, the connector 22 is slid into the outer housing 21 and the male thread 25 is threaded into the grip 13. A hexagonal wrench is then passed into the hexagonal bore 23 of the connector 22 and rotated to wrench the thread 25 into an internal thread in the grip 13 thereby firmly securing the housing 21 to the grip 13. At this time, the housing 21 abuts the grip 13 and the collar 32 of the connector 22 clamps against the housing 21.

Next, the plug 27 is fitted into the inner housing 26 and these two components are secured together, as by ultrasonic welding, and moved into the outer housing 21 with the plug 27 facing the connector 22. The inner housing 26 is then fixedly secured to the first housing 21, for example, by screws or ultrasonic welding.

The spray-head assembly 14 also includes a spray head 40 that is rotatably mounted on the inner housing 26. The spray head 40 is initially formed of two pieces, for example, of plastic, that are secured together, for example, by ultrasonic welding to form a one-piece unit.

The spray-head 40 is of annular shape and is held in place by a screw 41 that passes through an opening in the spray head 40 into threaded engagement with a counter-bore 42 in the inner housing 26.

The spray head 40 has a plurality of circumferentially spaced apart ports 43, i.e. five, in the inner surface (only one of which is shown in FIG. 4) that are disposed to be brought into selective communication with the passage 34 in the inner housing 26.

The spray head 40 is also provided with a pair of internal chambers, which are partitioned from each other. Each chamber 44, 45 communicates with the passage 34 in the inner housing 26 via a respective port (not shown).

Referring to FIG. 4, the spray head 40 has an opening in the outer surface that communicates with one of the ports 43 and that is provided with a spout 46 of cylindrical shape in order to discharge a full stream of water from the spray head 40.

The spray head 40 also has a second opening in the outer surface that communicates with a second port 43 and that is provided with a spout 47 of cylindrical shape that is of a smaller diameter than the spout 46 in order to discharge a jet stream from the spray head 40.

The spray head 40 also has a third opening in the outer surface that communicates with a third port 43 and that is provided with a plate 48 with a plurality of openings 49 to discharge a water mist from the spray head 40.

The internal chamber 44 of the spray head 40 communicates with a pair of concentric rings of openings 50 disposed centrally of the spouts 46, 47 and plate 48. These openings 50 serve to deliver a plurality of streams of water for a center spray pattern from the spray head 40.

The second internal chamber 45 communicates with a pair of concentric rings of openings 51 disposed peripherally of the spray head 40 outside the spouts 46, 47 and wall 48. These openings 51 serve to deliver a shower spray pattern from the spray head 40.

Referring to FIG. 1, the spray head 40 has a polygonal-shaped outer periphery in order to provide a gripping surface for manual gripping and rotating of the spray head 40 relative to the inner housing 26. In addition, the spray head 40 has a flattened peripheral surface 52 which can be provided with indicia corresponding to and indicative of the positions of the spray head 40 relative to the inner housing 26 for ease of alignment.

The spray head 40 also has plurality of circumferentially spaced recesses 53 into which the plunger 38 may be biased in order to hold the spray head 40 in one of the selected positions of use.

When the spray head 40 rotates relative to the inner housing 26, the O-ring 36 about the terminal end of the passage 34 provides an effective seal to prevent leakage of water between the inner housing 34 and the surfaces of the spray head 40.

In order to mount the spray head 40 on the inner housing 26, the spray head 40 is simply slid over the inner housing 26 and the screw 41 threaded into place in order to retain the spray head 40 in fixed but rotatable relation to the inner housing 26.

Referring to FIG. 1, the spray head assembly 14 may be constructed so as to extend essentially coaxially from the grip 13. However, the spray head assembly may be constructed to extend angularly of the grip 13′ as indicated in FIG. 5 wherein like reference characters indicate like parts as above.

The invention thus provides a pre-rinse assembly that can be manipulated by a user in order to deliver one of at least five different sprays for different purposes. For example, a full stream of water may be delivered via the spout 46 for general washing purposes. A jet stream may be delivered via the spout 47 in order to increase the scrubbing or scouring effect of the water on food particles that are more adherent to a utensil being cleaned. A mist may be delivered for purposes of spraying food, such as lettuce, to maintain the crispness of the food. Further, a center spray may be provided via the openings 50 for rinsing purposes or a shower may be provided via the openings 51 for washing food items in bulk.

1. A pre-rinse assembly comprising
a hose sub-assembly having an inlet end for connecting to a riser and a discharge end at an opposite end;
a grip secured to said discharge end of said hose sub-assembly and having a duct for a flow of water; and
a spray head assembly including a housing secured to said grip and having a passage in communication with said grip to conduct a flow of water therefrom, and a spray head rotatably mounted on said housing and having a plurality of openings for selective communication with said passage in said housing to discharge water therefrom in at least three different spray patterns.

2. A pre-rinse assembly as set forth in claim 1 wherein said spray head has at least three circumferentially spaced apart ports for selective communication with said passage in said housing, one of said ports communicating with a first spout of a first diameter for discharge of a full stream of water therethrough, a second of said ports communicating with a second spout of a diameter less than said diameter of said first spout for discharge of a jet stream of water therethrough and a third of said ports communicating with a plate having a plurality of outlets for discharge of a water mist therethrough.

3. A pre-rinse assembly as set forth in claim 2 wherein said spray
head has a fourth port for selective communication with said passage in said housing, an internal chamber in communication with said fourth port to receive a flow of water therefrom and at least a pair of concentric rings of openings in communication with said chamber for discharge of a plurality of water streams therethrough.

4. A pre-rinse assembly as set forth in claim 3 wherein said pair of concentric rings of outlets are disposed centrally of said pre-rinse to discharge a center spray pattern of water.

5. A pre-rinse assembly as set forth in claim 3 wherein said pair of concentric rings of outlets are disposed peripherally of said spray to discharge a shower spray pattern of water.

6 A pre-rinse assembly as set forth in claim 1 wherein said pre-rinse has a port for selective communication with said passage in said housing, an internal chamber in communication with said port to receive a flow of water therefrom and at least a pair of concentric rings of outlets in communication with said chamber for discharge of a plurality of water streams therethrough.

7 A pre-rinse assembly as set forth in claim 6 wherein said pair of concentric rings of outlets are disposed centrally of said pre-rinse to discharge a center spray pattern of water.

8 A pre-rinse assembly as set forth in claim 1 wherein said pair of concentric rings of outlets are disposed peripherally of said pre-rinse to discharge a shower spray pattern of water.

9. A pre-rinse assembly as set forth in claim 1 wherein said pre-rinse has a plurality of circumferentially spaced recesses and which further comprises a spring biased detent disposed in fixed relation to said housing for selective placement coaxially in one of said recesses to retain said in a selected position relative to said housing.

10. A spray head assembly comprising
a first housing having a passage for a flow of water;
a connector mounted in and projecting from said housing in non-rotatable relation, said connector having an exterior thread thereon and an internal passage to conduct a flow of water therethrough;
a second housing secured to said first housing and having a passage in communication with said passage in said first housing to conduct a flow of water therethrough; and
a spray head rotatably mounted on said second housing and having a plurality of openings for selective communication with said passage in said second housing to discharge water therefrom.

11. A spray head assembly as set forth in claim 10 further comprising a hollow plug mounted coaxially between said second housing and said connector to retain said connector in said first housing.

12. A spray head assembly as set forth in claim 10 wherein said spray head has at least three circumferentially spaced apart ports for selective communication with said passage in said second housing, one of said ports communicating with a first spout for discharge of a full stream of water therethrough, a second of said ports communicating with a second spout of smaller diameter than said first spout for discharge of a jet stream of water therethrough and a third of said ports communicating with a plate having a plurality of outlets for discharge of a mist therethrough.

13. A spray head assembly as set forth in claim 12 wherein said spray head has a fourth port for selective communication with said passage in said second housing, an internal chamber in communication with said fourth port to receive a flow of water therefrom and at least a pair of concentric rings of openings in communication with said chamber for discharge of a plurality of water streams therethrough.

14. A spray head assembly as set forth in claim 13 wherein said pair of concentric rings of outlets are disposed centrally of said spray head to discharge a center spray pattern of water.

15. A spray head assembly as set forth in claim 13 wherein said pair of concentric rings of outlets are disposed peripherally of said spray head to discharge a shower spray pattern of water.

16. A spray head assembly as set forth in claim 10 wherein said spray head has a port for selective communication with said passage in said second housing, an internal chamber in communication with said port to receive a flow of water therefrom and at least a pair of concentric rings of openings in communication with said chamber for discharge of a plurality of water streams therethrough.

17. A spray head assembly as set forth in claim 10 wherein said pair of concentric rings of outlets are disposed centrally of said spray head spray head to discharge a center spray pattern of water.

18. A spray head assembly as set forth in claim 10 wherein said pair of concentric rings of outlets are disposed peripherally of said spray head to discharge a shower spray pattern of water.

19. A spray head assembly as set forth in claim 10 wherein said spray head has a plurality of circumferentially spaced recesses and which further comprises a spring biased detent in said second housing for selective placement coaxially in one of said recesses to retain said spray head in a selected position relative to said second housing.
